(19) United States
(12) Patent Application Publication
(10) Pub. No.: US 2002/0175906 A1
(43) Pub. Date: Nov. 28, 2002

(54) Flat panel display and driving method thereof

(75) Inventor: Seong Hak Moon, Gunpo (KR)

Correspondence Address: FLESHNER & KIM, LLP, P.O. Box 221200, Chantilly, VA, 20153-1200, US

(73) Assignee: LG Electronics Inc.

(21) Appl. No.: 10/152,677

(22) Filed: May 23, 2002

(30) Foreign Application Priority Data
May 24, 2001 (KR) 28755/2001

(51) Int. Cl. G09G 5/00

(52) U.S. Cl. 345/204

(57) ABSTRACT

A driving method of a flat panel display capable of reducing a peak current generated in driving the flat panel display is disclosed in which a data pulse is supplied to a data line and a scan pulse is supplied to a scan line in synchronization with the data line. A data pulse having a certain tilt is supplied to the data line or a scan pulse having a certain tilt is supplied to the scan line.

### BACKGROUND OF THE INVENTION

1. Field of the Invention

The present invention relates to a flat panel display and its driving method, and more particularly, to a flat panel display that is capable of reducing a peak current generated in its driving, and a driving method thereof.

2. Description of the Background Art

Recently, various flat panel display s are being developed to reduce a weight and a volume, the shortcomings of a cathode ray tube (CRT).

The flat panel display s include a liquid crystal display (LCD), a field emission display (FED), a plasma display panel, an electro-luminescence (EL), and the like.

In order to improve a display quality, researches are being actively conducted to heighten a luminance, a contrast and a colorimetric purity of the flat panel display.

The FED is divided into a tip type FED in which a high electric field is concentrated on an acuminate emitter to discharge electrons by a quantum mechanical tunnel effect, and a metal insulator metal (MIM) FED in which a high electric field is concentrated on a metal having a certain area to discharge electrons by the quantum mechanical tunnel effect.

FIG. 1 is a perspective view of a tip type field emission display in accordance with a conventional art, and FIG. 2 is a sectional view of the tip type FED in accordance with the conventional art.

As shown in FIGS. 1 and 2, the FED includes an upper glass substrate 2 on which an anode electrode 4 and a fluorescent material 6 are stacked; and a field emission array 32 formed on the lower glass substrate 8.

The field emission array 32 includes a cathode electrode 10 and a resistance layer 12 sequentially formed on the lower substrate 8, a gate insulation layer 14 and an emitter 22 formed on the resistance layer 12, and a gate electrode 16 formed on the gate insulation layer 14.

The cathode electrode 10 supplies current to the emitter 22, and the resistance layer 12 restricts an overcurrent applied to the emitter 2 from the cathode electrode 10 in order to supply a uniform current to the emitter 22.

The gate insulation layer 14 insulates the cathode electrode 10 and the gate electrode 16.

The gate electrode 16 is used as a fetch electrode for fetching electrons.

A spacer 40 is installed between the upper glass substrate 2 and the lower glass substrate 8.

The spacer 40 supports the upper glass substrate 2 and the lower glass substrate 8 so that a high vacuum state can be maintained between the upper glass substrate 2 and the lower glass substrate 8.

In order to display a picture, a negative polarity (−) cathode voltage is applied to the cathode electrode 10 and a positive polarity (+) anode voltage is applied to the anode electrode 4. And, a positive polarity (+) gate voltage is applied to the gate electrode 16.

Then, electron beams 30 emitted from the emitter 22 collide with the fluorescent material 6 of red, green blue colors to excite the fluorescent material (phosphor). At this time, a visible ray of one of red, green and blue colors is luminescent.

In such a tip type FED, the electron emission amount is determined depending on characteristics of the emitter used for the electron emission. Thus, every emitter included in one FED should be fabricated uniform.

However, with the current fabrication process, it is not easy to fabricate for every emitter included in one FED to have the uniform characteristics. In addition, much process time is consumed to fabricate the emitter.

Moreover, since electrons are emitted from the acuminated emitter, it is difficult to make a gap between the cathode electrode 10 and the gate electrode 16 to be small, for which, thus, a voltage as high as scores of volt to a hundred volt should be applied between the two electrodes.

Thus, much power is consumed by the voltage applied to the cathode electrode 10 and the gate electrode 16.

FIGS. 3A and 3B show a pixel cell of the flat type FED in accordance with the conventional art.

As shown in FIGS. 3A and 3B, the pixel cell of the flat type FED includes an upper substrate 42 on which an anode electrode 44 and a fluorescent material 46 are stacked and a field emission array 56 formed on the lower substrate 48.

The field emission array 56 includes a scan electrode 50 formed on the lower substrate 48, an insulation layer 52 and a data electrode 54.

In order to display a picture, a negative polarity (−) scan pulse is applied to the scan electrode 50 and a positive polarity (+) data pulse is applied to the data electrode 54. And, a positive polarity (+) anode voltage is applied to the anode electrode 44.

Then, electrons are tunneled from the scan electrode 50 to the data electrode 54 and accelerated toward the anode electrode 44.

The electrons collide with the red, green and blue fluorescent material 46 to excite the fluorescent material 46. At this time, a visible ray of one of red, green and blue colors is luminescent according to the fluorescent material 46.

In the flat type FED, the scan electrode 50 and the data electrode 54 can be closed compare to the tip type FED in a manner that the two electrodes face each other with certain areas (the insulation film can be processed by a thin film process), the flat type FED can be driven at a lower voltage compared to the tip type FED.

Namely, a few to 10V voltage is applied to the scan electrode 50 and the data electrode 54 of the flat type FED.

In addition, since the scan electrode 50 and the data electrode 54 of the flat type FED that emit the electrons have a certain area, respectively, the scan electrode 50 and the data electrode 54 can be fabricated with a simple fabrication process compared to the tip type FED.

FIG. 4 illustrates driving waveforms supplied to the flat type FED in accordance with the conventional art.

As shown in FIG. 4, in the conventional flat type FED, the negative polarity (−) scan pulse (SP) is sequentially supplied to the scan line (S) and a positive polarity (+) data pulse (DP) in synchronization with the negative polarity (−) scan pulse (SP) is supplied to the data line (D).

From the pixel cell to which the scan pulse (SP) and the data pulse (DP) have been supplied, electrons are emitted due to a voltage difference between the scan pulse (SP) and the data pulse (DP).

FIG. 5 illustrates an FED in which pixel cells shown in FIGS. 3A and 3B are disposed in a matrix form.

As shown in FIG. 5, if −5V scan pulse (SP) is applied to a first scan line (S1) and a 5V data pulse (DP) is applied to the data line (D), a 10V voltage difference occurs in the first pixel cells (P1) formed at the first scan line (S1). Accordingly, electrons are discharged from the first pixel cells (P1) to which the data pulse (DP) has been supplied.

At this time, since different data value are supplied to the cells (D1˜Dn) of the data line, the pixel cells can be turned on or off. That is, the pixel cells at the point where the scan line (S1) and the cells (D1˜Dn) of the data line cross each other are turned on/off according to a value of the data line.

At this time, widths and/or amplitudes of the data pulse (DP) are differently set according to a gray scale. For example, when a high fray scale is expressed, the width and/or amplitude of the data pulse (DP) is highly set, while when a low gray scale is expressed, the width and/or the amplitude of the data pulse (DP) is lowly set.

Meanwhile, since only 5V, that is, only the data pulse (DP), is applied to the second˜the mth pixels (P2˜Pm) formed at the second˜the mth scan lines (S2˜Sm), no electrons are discharged.

Thereafter, such a process is repeatedly perform so that the scan pulse (SP) and the data pulse (DP) are sequentially applied up to the mth scan line (Sm) to drive the first˜the mth pixel cells (P1˜Pm) to display a picture.

After the picture is displayed, a positive polarity (+) reset pulse (RP) is applied to the first˜the mth scan lines (S1˜Sm).

When the reset pulse (RP) is applied to the first˜the mth scan lines (S1˜Sm), electrons charged in the first˜the mth pixel cells (P1˜Pm) are removed.

However, in such a flat type FED, as shown in FIGS. 3A and 3B, the insulation layer 52 is formed a thin film, so that its capacitance component becomes very large. That is, since the insulation layer 62 of the intermediate layer is very thin, a dielectric layer is made a very thin film in an equation of C=ε×s/d (wherein ε is a dielectric constant, d is a dielectric constant thickness, and s is a cell area). Thus, the capacitance component becomes very large.

If the capacitance component of the flat type FED becomes large, an instantaneous peak current value is heightened by equation (1) as shown below.

$$ip = \frac{CV}{tr} \qquad equation ( 1 )$$

wherein Ip is a current peak value, C is a capacitance, V is a drive voltage, and tr is a tilt of a pulse.

This will now be described in detail with reference to FIG. 6.

FIG. 6 illustrates waveforms showing a peak current generated by the waveforms of FIG. 4.

As shown in FIG. 6, when the scan pulse (SP) and the data pulse (DP) are supplied, a high peak current value (Hip) appears.

When the high peak current (Hip) is repeatedly supplied to the insulation layer 52 of the thin film, the insulation layer 52 is damaged. Then, the durability of the flat type FED is shortened, and driving drives are damaged by the high peak current (Hip).

As described above, the conventional flat type FED has the following problems.

That is, first, since the high peak current (Hip) is repeatedly supplied to the insulation layer 52 of the thin film, the insulation layer 52 is damaged.

Secondly, the durability of the FED is shortened owing to the damage of the insulation layer 52.

In addition, the driving drivers in the flat type FED are damaged due to the peak current (Hip).

### SUMMARY OF THE INVENTION

Therefore, an object of the present invention is to provide a flat panel display that is capable of reducing a peak current generated when a flat panel display is driven, and its driving method.

To achieve these and other advantages and in accordance with the purpose of the present invention, as embodied and broadly described herein, there is provided a driving method of a flat panel display including the steps of: supplying a data pulse to a data line; and supplying a scan pulse synchronized with the data pulse and having a certain tilt to a scan line.

To achieve the above objects, there is also provided a driving method of a flat panel display including the steps of: supplying a data pulse having a certain tilt to a data line; and supplying a scan pulse synchronized with the data pulse and having a certain tilt to a scan line.

To achieve the above objects, there is also provided a driving method of a flat panel display including the steps of: supplying a data pulse to a data line; and supplying a scan data synchronized with the data pulse and having a delay time to supply a scan pulse to a scan line.

To achieve the above objects, there is also provided a flat panel display having a data driving unit for supplying a data pulse to a panel and a scan driving unit for supplying a scan pulse to the panel, wherein the scan driving unit determines a tilt of the scan pulse and supplies the scan pulse having the determined tilt to the panel.

In the flat panel display of the present invention, the scan driving unit includes: a first switching device connected to a ground voltage source; a second switching device connected to a negative polarity voltage source; a first pulse driving unit for driving the first switching device; a second pulse driving unit for driving th second switching device; a lamp pulse generator installed between the second switching device and the second pulse driving unit to determine a timing of a pulse supplied from the second pulse driving unit; and a tilt controller installed between the lamp pulse generator and the second switching device to determine a tilt of a pulse supplied from the lamp pulse generator.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view of a tip type FED in accordance with a conventional art;

FIG. 2 is a sectional view of the tip type FED in accordance with the conventional art;

FIGS. 3A and 3B show pixel cells of a flat type FED in accordance with a conventional art;

FIG. 4 illustrates driving waveforms supplied to the flat type FED in accordance with the conventional art;

FIG. 5 shows an FED in which the pixel cells of FIGS. 3A and 3B are disposed in a matrix form;

FIG. 6 illustrates waveforms showing peak currents generated by the waveforms of FIG. 4;

FIG. 7 illustrates driving waveforms supplied to a flat type FED in accordance with a first embodiment of the present invention;

FIG. 8 illustrates waveforms showing peak currents generates by the waveforms of FIG. 7;

FIG. 9 illustrates driving waveforms supplied to a flat type FED in accordance with a second embodiment of the present invention;

FIG. 10 illustrates driving waveforms supplied to a flat type FED in accordance with a third embodiment of the present invention;

FIG. 11 is a block diagram showing a driving apparatus of the flat type FED in accordance with the first through the third embodiments of the present invention; and

FIG. 12 is a block diagram showing a scan driving unit of FIG. 11.

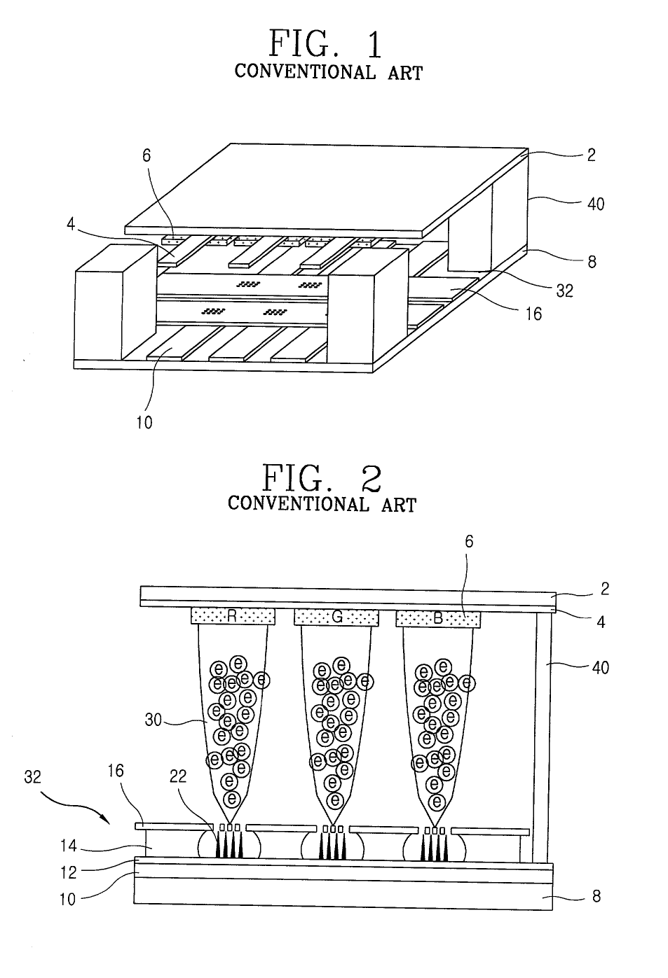

### DETAILED DESCRIPTION OF THE PREFERRED EMBODIMENTS

Reference will now be made in detail to the preferred embodiments of the present invention, examples of which are illustrated in the accompanying drawings.

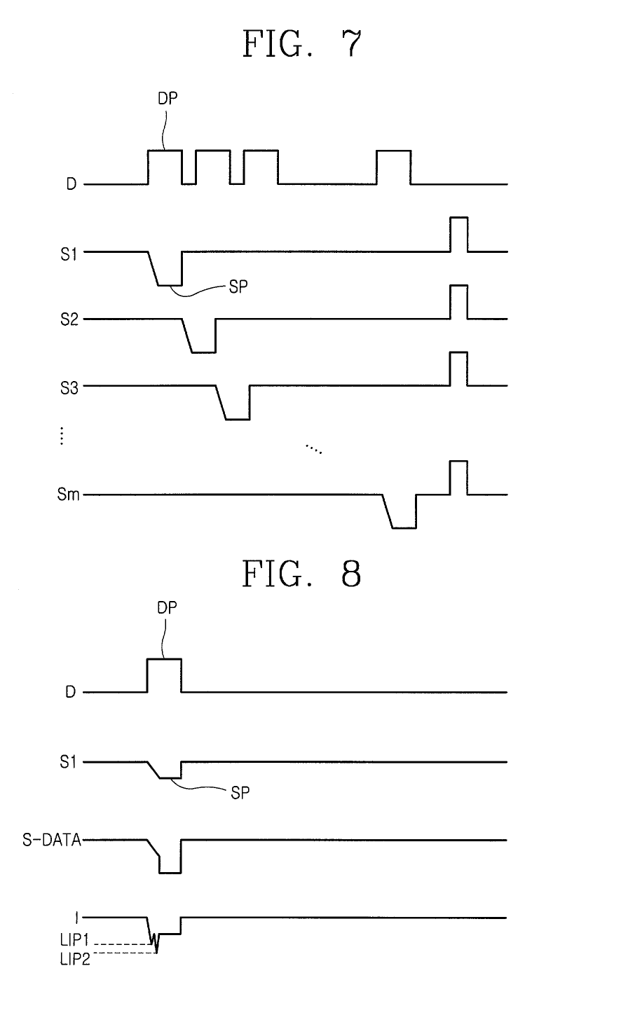

A flat panel display and its driving method of the present invention are capable of reducing a peak current generated in driving a flat panel display by allowing at least more than one of data (a video data) and a scan data for supplying a data pulse and a scan pulse when the scan pulse is supplied to a scan line so as to be synchronized with the data pulse, to have a certain tilt, of which preferred embodiments will now be described in detail with reference to FIGS. 7 through 12.

FIG. 7 illustrates driving waveforms supplied to a flat type FED in accordance with a first embodiment of the present invention.

As shown in FIG. 7, in the flat type FED, a negative polarity (−) scan pulse (SP) having a certain tilt is sequentially supplied to the scan lines (S1˜Sm) and a positive polarity (+) data pulse (DP) synchronized with the negative polarity scan pulse (SP) is supplied to the data line (D).

Electrons are discharge due to a voltage difference between the scan pulse (SP) and the data pulse (DP) from the pixel cell to which the scan pulse (SP) and the data pulse (DP) have been simultaneously supplied.

In the first embodiment of the present invention, the scan pulse (SP) supplied to the scan line (S) has a certain tilt, which will now be described in detail with reference to FIG. 8.

FIG. 8 illustrates waveforms showing peak currents generates by the waveforms of FIG. 7.

As shown in FIG. 8, the scan data (s-data) for generating the scan pulse (SP) having a certain tilt has a certain tilt.

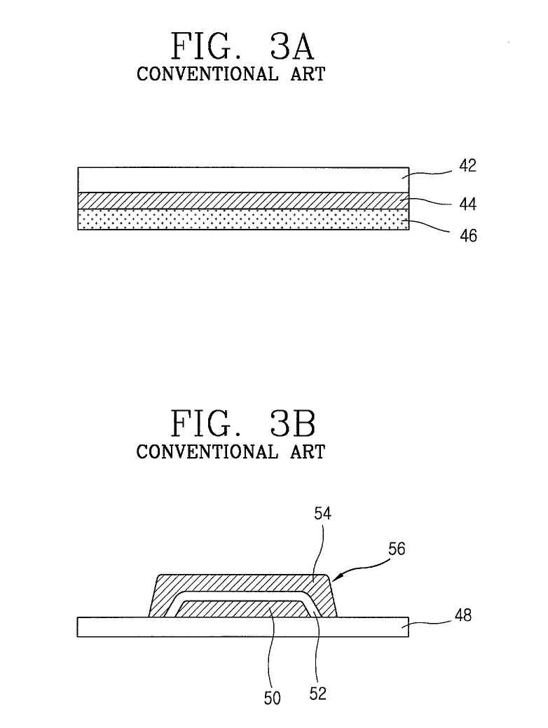

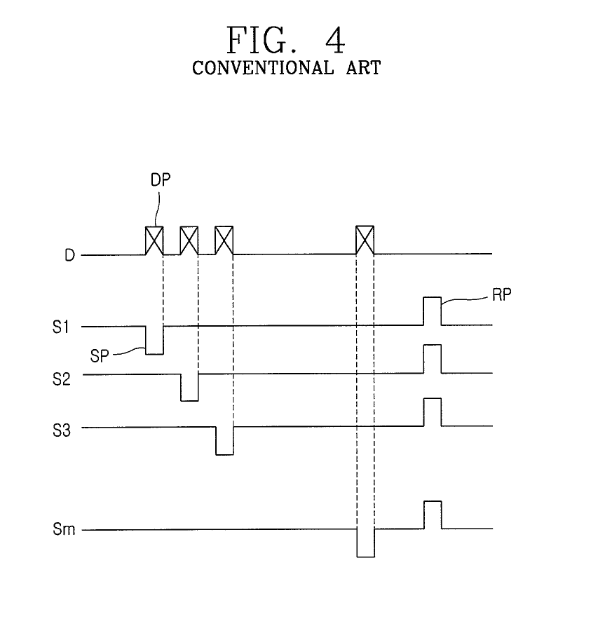

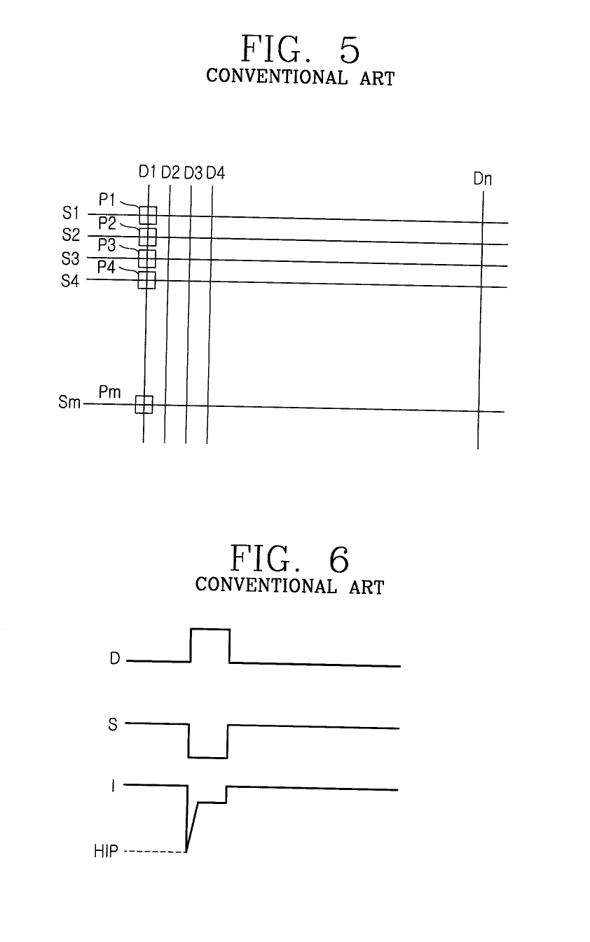

When the scan pulse (SP) having a certain tilt is supplied, a peak current (Lip) lower than that of the conventional art according to equation (1) flows to the pixel cell. Thus, a damage to the insulation layer 52 formed as a thin film as shown in FIG. 3 can be minimized.

In this respect, the scan data (s-data) signifies a voltage difference between the scan pulse and the data pulse, that is, a voltage pulse applied to one cell.

In the first embodiment of the present invention, the scan data (s-data) is increased with a certain tilt, and when it goes beyond a certain voltage, it is sharply increased. Accordingly, two times of peaks current (Lip1, Lip2) flow to the insulation layer 52.

That is, when the scan data (s-data) is increased with a certain tilt, the first peak current (Lip1) flows, and when the scan data (s-data) rapidly goes up to above a certain voltage (a voltage higher than a threshold voltage), the second peak current (Lip2) flows. These peak currents have a lower voltage than that of the conventional art, a damage to the insulation layer 52 can be minimized.

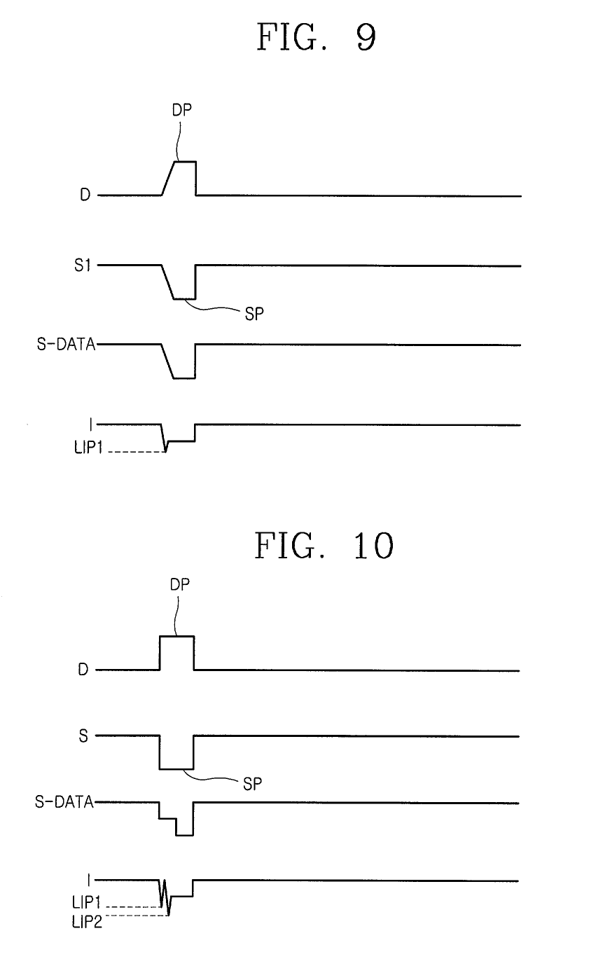

FIG. 9 illustrates driving waveforms supplied to a flat type FED in accordance with a second embodiment of the present invention.

As shown in FIG. 9, in a flat type FED in accordance with a second embodiment of the present invention, a negative polarity (−) scan pulse (SP) having a certain tilt is sequentially supplied to the scan line (S), and a data pulse (DP) synchronized with the negative polarity (−) scan pulse (SP) and having a certain tilt is supplied to the data line (D).

Electrons are discharged due to a voltage difference between the scan pulse (SP) and the data pulse (DP) from the pixel cell to which the scan pulse (SP) and the data pulse (DP) have been simultaneously supplied.

In the second embodiment of the present invention, in order to supply the scan pulse (SP) having a certain tilt to the scan lines (S1˜Sm), the scan data (s-data) having a certain tilt is supplied.

The scan data (s-data) is gradually increased up to a certain voltage with a certain tilt.

When the scan data (s-data) is gradually increased with a certain tilt, the scan pulse (SP) is gradually increased with a certain tilt.

Thus, according to the equation 1, the low peak current (Lip) flows to the insulation layer 52 and a damage to the insulation layer 52 formed as a thin film can be minimized.

Meanwhile, the data pulse (DP) having a certain tilt is generated in the same manner with the scan pulse (SP).

FIG. 10 illustrates driving waveforms supplied to a flat type FED in accordance with a third embodiment of the present invention.

As shown in FIG. 10, a square wave data pulse (DP) and scan pulse (SP) are supplied to a flat type FED in accordance with a third embodiment of the present invention.

The scan data (s-data) for supplying the scan pulse (SP) makes a phase difference between the scan pulse and the data pulse.

The scan data (s-data) is increased up to a certain voltage (a threshold voltage) without a tilt, and after the certain voltage is maintained for a certain time, the scan data (s-data) is increased up to a maximum voltage, that is, the sum of the voltage of the scan pulse and the voltage of the data pulse, without a tilt. Thus, two times of peak currents (Lip1, Lip2) flow to the insulation layer 52.

Namely, when the scan data (s-data) is increased up to a certain voltage, the first peak current (LIp1) flows to the insulation layer 52. When the scan data (s-data) is maintained at a certain voltage for a certain time (a few μs), a low current flows to the insulation layer 52.

After the scan data (s-data) is maintained at a certain voltage for a certain time, when it is increased up to a certain voltage, the second peak current (LIp2) flows to the insulation layer 52.

The peak currents (Lip1, LIp2) have lower values compared to those in the conventional art, a damage to the insulation layer 52 can be minimized.

FIG. 11 is a block diagram showing a driving apparatus of the flat type FED in accordance with the first through the third embodiments of the present invention.

As shown in FIG. 11, a driving apparatus of the flat type FED of the present invention includes first and second data driving units 68 and 70 for supplying a data pulse (DP) to a panel 74; a scan driving unit 72 for supplying a scan pulse (SP) to the panel 74; a first frame memory 62 for storing a first data of one frame; a second frame memory 64 for storing a second data of one frame; a timing controller 66 for controlling a supply timing of the scan pulse (SP) and the data pulse (DP); and a controller 60 for controlling the timing controller 66, the first frame memory 62 and the second frame memory 64.

The operation of the driving apparatus for generating driving waveforms in accordance with first through third embodiments of the present invention will now be described in detail.

First, the controller 60 receives an image signal and a synchronous signal from an external source.

The controller 60 separates first and second data from the image signal and supplies the first and second data to the first and second frame memories 62 and 64.

In addition, the controller 60 supplies the synchronous signal to the timing controller 66.

The first and second frame memories 62 and 64 temporarily store the first and second data, and supply the data of one frame as stored to the first and second data driving units 68 and 70. Herein, the stored first and second data is data of one frame.

Thereafter, the timing controller 66 supplies a first control signal to the scan driving unit 72, and supplies a second control signal to the first and second data driving units 68 and 70.

The scan driving unit 72 receives the first control signal and sequentially supplies the scan pulse (SP) to the scan lines (S) formed at the panel 74.

The first and second data driving units 68 and 70 receive the second control signal and supply the data (that is, the data pulse) to the data line (D) formed at the panel 75 so as to be synchronized with the scan pulse (SP).

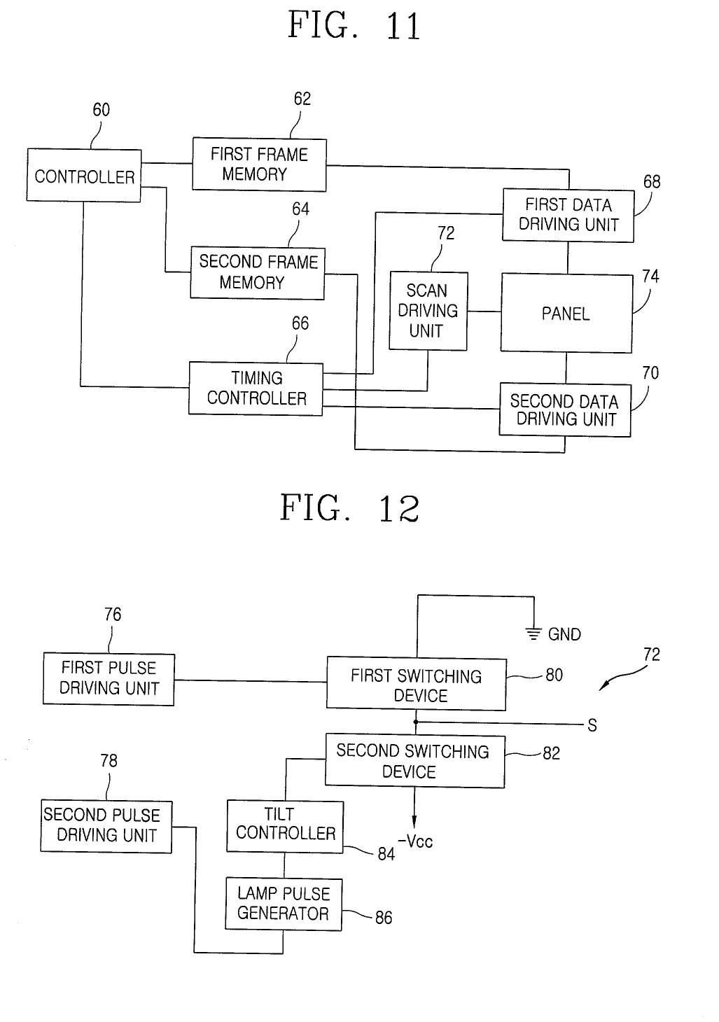

Meanwhile, the scan driving unit 72 should supply the scan pulse (SP) having a certain tilt to the scan line (S), for which the scan driving unit 72 is constructed as shown in FIG. 12.

FIG. 12 is a block diagram showing the scan driving unit of FIG. 11.

As shown in FIG. 12, the scan driving unit 72 includes: a first switching device 80 connected to a ground voltage source (GND); a second switching device 82 connected to a negative polarity (−) voltage source (−Vcc); a first pulse driving unit 76 for driving the first switching device 80; a second pulse driving unit 78 for driving the second switching device 82; a lamp pulse generator 86 installed between the second switching device 82 and the second pulse driving unit 78 and determining a timing of a pulse supplied from the second pulse driving unit 78; and a tilt controller 84 installed between the lamp pulse generator 86 and the second switching device 82 and determining a tilt of a pulse supplied from the lamp pulse generator 86.

The operation of the scan driving unit 72 will now be described in detail.

First, the first pulse driving unit 76 receives a control signal from the timing controller 66. Upon receipt of the control signal, the first pulse driving unit 76 generates a square wave pulse and supplies the square wave pulse to the first switching device 80.

The first switching device 80 is turned on by the square wave pulse supplied from the first pulse driving unit 76 and connects the ground voltage source (GND) and the scan line (S).

Namely, when the first switching device 80 is turned on, the ground voltage is supplied to the scan line (S).

The second pulse driving unit 78 receives a control signal from the timing controller 66. Upon receipt of the control signal, the second pulse driving unit 78 generates a square wave pulse. The square wave pulse generated from the second pulse driving unit 78 is supplied to the lamp pulse generator 89.

In order to supply the driving waveforms according to the first through third embodiments of the present invention, the lamp pulse generator 89 controls a timing of the square wave pulse supplied from the second pulse driving unit 78.

For example, in order to generate the driving waveforms in accordance with the third embodiment of the present invention as shown in FIG. 10, the square wave pulse passes up to a certain voltage, and then the square wave pulse is delayed for a certain time at the certain voltage and supplied to the tilt controller 84.

The tilt controller 84 includes an RC integrating circuit.

The pulse waveform supplied from the lamp pulse generator 86 has a certain tilt by the tilt controller 84.

The pulse (that is, the scan data) having a certain tilt generated from the tilt controller 84 is supplied to the second switching device 82.

The second switching device 82 is gradually turned on by the scan data having the certain tilt supplied from the tilt controller 84 and supplies the scan pulse (SP) having a certain tilt to the scan line (S).

The tilt of the scan pulse (SP) is determined by a resistance value and a capacitance value of the RC integrating circuit included in the tilt controller 84.

As so far described, the flat panel display and its driving method of the present invention has many advantages.

That is, for example, first, by controlling a tilt of at least more than one pulse among the scan pulse and the data pulse, the peak current flowing to the pixel cell can be minimized.

Secondly, since the minimum peak current (Lip) is repeatedly supplied to the insulation layer of the thin film, the insulation layer can be prevented from damaging.

Thirdly, since the insulation layer is prevented from damaging, the life span of the flat type FED can be lengthened.

Lastly, the driving drivers of the flat type FED can be prevented from damaging thanks to the minimum peak current (LIp).

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A driving method of a flat panel display comprising the steps of:
supplying a data pulse to a data line; and
supplying a scan pulse synchronized with the data pulse and having a certain tilt to a scan line.

2. The method of claim 1, wherein the scan pulse has a certain tilt by a scan data having a certain tilt.

3. The method of claim 2, wherein the scan data is increased up to a certain voltage with a certain tilt, and then, increased without a tilt from above the certain voltage.

4. The method of claim 1, wherein the scan pulse having a certain tilt is supplied to reduce a peak current flowing to a pixel cell.

5. A driving method of a flat panel display comprising the steps of:
supplying a data pulse having a certain tilt to a data line; and
supplying a scan pulse synchronized with the data pulse and having a certain tilt to a scan line.

6. The method of claim 5, wherein the scan pulse and the data pulse have a certain tilt, respectively, by a data having a certain tilt.

7. The method of claim 6, wherein the data is gradually increased up to a certain voltage.

8. A driving method of a flat panel display comprising the steps of:
supplying a data pulse to a data line; and
supplying a scan data synchronized with the data pulse and having a delay time to supply a scan pulse to a scan line.

9. The method of claim 8, wherein the scan data is increased up to a certain voltage without a tilt, maintained at the certain voltage for a certain time, and increased up to a certain voltage without a tilt.

10. A driving method of a flat panel display supplying a data pulse to a data line and supplying a scan pulse to a scan line in synchronization with the data line, wherein a data pulse having a certain tilt is supplied to the data line, or a scan pulse having a certain tilt is supplied to the scan line.

11. The method of claim 10, wherein the scan pulse has a certain tilt by the scan data having a certain tilt.

12. The method of claim 11, wherein the scan data has a delay time.

13. The method of claim 11, wherein the scan data is increased up to a certain voltage without a tilt, maintained at the certain voltage for a certain time, and then increased up to a certain voltage without a tilt.

14. The method of claim 11, wherein the data pulse has a certain tilt by a data having a certain tilt.

15. The method of claim 14, wherein the data is gradually increased up to a certain voltage.

16. The method of claim 14, wherein the scan data and the data are increased up to a certain voltage with a tilt, and then increased without a tilt from above the certain voltage.

17. The method of claim 10, wherein the scan pulse having a certain tilt is supplied to reduce a peak current flowing to a pixel cell.

18. The method of claim 10, wherein the data pulse having a certain tilt is supplied to reduce a peak current flowing to a pixel cell.

19. A flat panel display having a data driving unit for supplying a data pulse to a panel and a scan driving unit for supplying a scan pulse to the panel, wherein the scan driving unit determines a tilt of the scan pulse and supplies the scan pulse having the determined tilt to the panel.

20. The flat panel display of claim 19, wherein the tilt is set by an integrating circuit.

21. The flat panel display of claim 20, wherein the integrating circuit includes a resistance and a capacitor and sets a tilt on the basis of a resistance value of the resistance and a capacity value of the capacitor.

22. A flat panel display comprising: a data driving unit for supplying a data pulse to a data line of a panel; a scan driving unit for supplying a scan pulse to a scan line of the panel; a first frame memory for storing a first data of one frame; a second frame memory for storing a second data of the one frame; a timing controller for controlling a timing of the scan pulse and the data pulse; and a controller for controlling the timing controller, the first frame memory and the second frame memory,
wherein the scan driving unit determines a tilt of the scan pulse and supplies the scan pulse having the determined tilt to the scan line.

23. The flat panel display of claim 22, wherein the scan driving unit comprises:
a first switching device connected to a ground voltage source;
a second switching device connected to a negative polarity voltage source;
a first pulse driving unit for driving the first switching device;
a second pulse driving unit for driving the second switching device;
a lamp pulse generator installed between the second switching device and the second pulse driving unit to determine a timing of a pulse supplied from the second pulse driving unit; and
a tilt controller installed between the lamp pulse generator and the second switching device to determine a tilt of a pulse supplied from the lamp pulse generator.

24. The flat panel display of claim 23, wherein the tilt controller includes an integrating circuit.

25. The flat panel display of claim 24, wherein the integrating circuit includes a resistance and a capacitor and sets a tilt on the basis of a resistance value of the resistance and a capacity value of the capacitor.
